(19) United States
(12) Patent Application Publication
(10) Pub. No.: US 2003/0126199 A1
(43) Pub. Date: Jul. 3, 2003

(54) Peer-to-peer namespace directory and discovery

(76) Inventors: Seemab Aslam Kadri, Hillsboro, OR (US); Shaofeng Yu, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/038,078

(22) Filed: Jan. 2, 2002

(51) Int. Cl. G06F 15/16

(52) U.S. Cl. 709/203

(57) ABSTRACT

A peer-to-peer network communication method is disclosed. When a server is active in the network, the server is queried for information about a desired peer. When the server is not active in the network, neighbor peers are queried for information about the desired peer.

### FIELD OF THE INVENTION

The present invention relates generally to the field of network communication. More specifically, the present invention relates to a method and a system for accessing resources from networked devices.

### BACKGROUND

Peer-to-peer communication can be described as direct exchange of resources between intelligent devices. To do this exchange, the devices need to be individually identified. Furthermore, the devices should be able to locate each other.

One implementation of peer-to-peer communication is Domain Name System (DNS). DNS is a distributed database used by Transmission Control Protocol/Internet Protocol (TCP/IP). DNS is a way that Internet domain names are located and translated into IP addresses. A domain name is a meaningful and easy-to-remember name for an IP address. There may be multiple DNS databases for different zones (e.g., .com, .edu, .gov, etc.). DNS provides naming for TCP/IP subnets. A client device (or peer) attached to a subnet has its IP address and hostname registered with the DNS server so that other client devices (or other peers) can look it up. When a new client device is installed into a zone, a DNS administrator allocates a hostname and an IP address for the new client device and registers these into the appropriate DNS server. The DNS server often executes on a dedicated computer system referred to as a Name Server. The look up process in the DNS is performed by a resolver. The resolver gets a domain name and returns an IP address, or it gets an IP address and looks up a domain name (also referred to as a hostname). Thus, DNS is a server-centric implementation.

Unlike DNS, Gnutella is a program that implements peer-to-peer communication without having a centralized server. Gnutella is an open, decentralized, peer-to-peer search system that is typically used to find files. There is no single centralized server computer responsible for keeping the network active. In Gnutella, a peer has information about some of its neighboring peer. This information has to be maintained individually by each peer. A peer does not have to connect to a central server like the DNS server in order to communicate with other peers. Instead, a peer connects to another peer by entering an IP address of the other peer. A disadvantage of the Gnutella program is that the information about the neighboring peers has to be maintained by a user in the local peer. The Gnutella program therefore cannot accommodate for changing IPs automatically, and its deployment is in an adhoc fashion.

### BRIEF DESCRIPTION OF THE DRAWINGS

The present invention is illustrated by way of example, and not limitation, in the figures of the accompanying drawings in which like references indicate similar elements and in which:

FIG. 1 illustrates a set of normal peers and a super-peer in a network.

FIG. 2 illustrates a peer-to-peer network with the normal peers having information about other normal peers.

FIG. 3 illustrates a discovery lookup process using the super-peer.

FIG. 4 illustrates a discovery lookup process without using the super-peer.

FIG. 5 is a flow diagram illustrating a process of locating information about a desired normal peer.

FIG. 6 is a flow diagram illustrating a process of querying the neighbor normal peers.

FIG. 7 illustrates an example of a network with more than one super-peer.

FIG. 8 illustrates one example of recovery of a super-peer.

FIG. 9 is a flow diagram illustrating a process of recovery of a super-peer.

FIGS. 10A and 10B are block diagrams illustrating examples of a super-peer and a normal peer, respectively.

### DETAILED DESCRIPTION

In one embodiment, a method or peer-to-peer communication is disclosed. A peer namespace directory includes information about peers in a network. In the peer namespace directory, one or more super-peers together include information about all of the peers in the network. Each of the other peers may include information about its neighbor peers. When a first normal peer searches for a second normal peer, the super-peer is queried. When the super-peer fails to respond, the first normal peer queries its neighbors.

Methods and systems for peer-to-peer communication are described herein. In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

In the following description, a normal peer refers to a peer that is not currently acting as a super-peer. A normal peer may become a super-peer when certain conditions are met. A normal peer may be any computing device capable of establishing a connection with another normal peer or a super-peer. For example, a normal peer may range from handheld devices (e.g., personal digital assistants (PDAs)) to powerful server computers. A handheld device generally has less capability as a normal computer due to its limited storage and processing capability. A powerful server computer generally has more capability. This is referred to as capability rating. A normal peer that has high capability rating may be able to take on additional responsibilities, such as, for example, becoming a super-peer.

A normal peer that participates in a peer-to-peer network according to the present invention is assigned a peer unique identifier (PUID). Assignment of the PUID may be performed using any existing algorithms that can generate a unique sequence. Of course, the PUID requirement also applies to the super-peer. The initial creation of the network occurs when a first normal peer sets up a namespace directory and declares it as a super-peer. This directory is where all of the additional normal peers are enlisted. When a device wants to join the network as a normal peer, the device contacts the super-peer and exchanges information with the super-peer. Thus, a set of two or more normal peers can collaborate with one another to form a network. The normal peers in the set may be on the same TCP/IP network subnet, or they may be on different TCP/IP network subnets as long as they have connectivity path to each other.

The directory is used to help with discovery. Discovery is a process of finding a set of information based on some criteria. “Lookup” is one form of discovery where one normal peer tries to find information about another peer based on peer name. Additional discovery may be performed using the information about the peer. For example, the information about a peer may advertise that the peer has available resources (e.g., free disk space, etc.) that can be shared with other normal peers. A normal peer may do a discovery for peers having “spare disk space”. The discovery may be assisted by the super-peer or the neighboring peers. The discovery may provide results in the form of a set of peer names (PUID's) identifying peers having spare disk spaces. A field may be defined in the information about a normal peer for such advertisement of resources. This field can be searched by the super-peer in its collection of other information about the normal peers in the network.

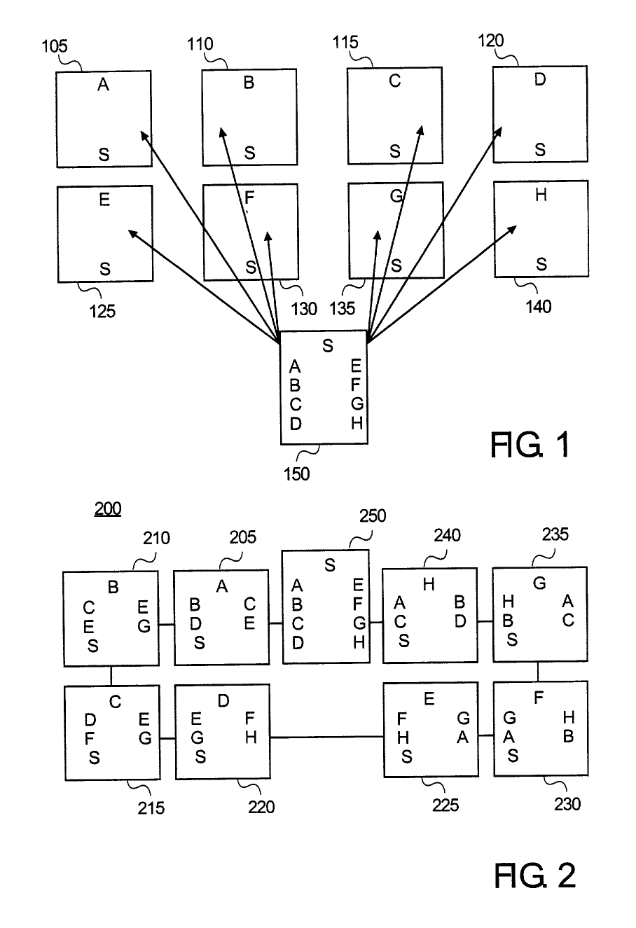

FIG. 1 illustrates a set of normal peers and a super-peer in a network. The network includes normal peers 105-140 (A-H) and a super-peer 150 (S). As illustrated, the super-peer 150 (S) includes information about all of the normal peers 105-140 in the network. The information may include, for example, the PUID of each of the normal peers 105-140, corresponding aliases, IP addresses, status (online or offline), timestamp information (e.g., date and time the information was last updated), etc. Using the information about the normal peers 105-140, the super-peer 150 serves to speed up discovery lookup of the normal peers 105-140. For example, when the normal peer 105 wants to communicate with the normal peer 140, the normal peer 105 queries the super-peer 150 to get information about the normal peer 140.

A normal peer has two types of storage of information, a static storage used to store assigned directory information set, and a dynamic cache used to store information about the other normal peers it recently looked up. This dynamic cache prevents wasteful lookups transparently. In one embodiment, when the normal peer 105 gets the information about the normal peer 140 from the super-peer 150, the normal peer 105 locally caches the information to use a next time it wants to communicate with the normal peer 140. If the locally cached information about the normal peer 140 becomes stale the next time the normal peer 105 try to use it, then the normal peer 105 will try to get the fresh information about the normal peer 140 from super-peer 150. Note that each of the normal peers 105-140 includes information about the super-peer 150. The super-peer 150 serves as a centralized server for the network which behaves in a client-server fashion.

Sizes of the static storage and the dynamic cache in a normal peer may be controlled via the capability rating. A normal peer having limited capability rating may not include information about any of the normal peers. A more powerful normal peer may include as much information about the other normal peers as a super-peer. Any method may be used to determine the amount of information about the other normal peers that a normal peer may include. For example, the amount of information may be determined based on a percentile such that a normal peer having a capability rating in the 90 percentile in comparison to the capability rating of all of the normal peers may include information of up to 50 percent of the total number of normal peers in the network, and so on. The determination may also be made by a random selection taking into consideration the capability rating of the normal peer.

Information in the static storage remains unchanged, whereas information in the dynamic cache may include most recently used (MRU) information only. Both the static storage and the dynamic cache will have “distinct” set of data (e.g., data/information about normal peers). That is, if the information about one normal peer is in the static storage, that information will not be duplicated in the dynamic cache. Typically, the lookup process first looks into static storage, then the dynamic cache, and then queries the super-peer until the information about a desired normal peer is located. A super-peer generally has a substantially big static storage. The static storage of the super-peer stores information about al of the normal peers in the network. This information in the super-peer defines the distributed directory.

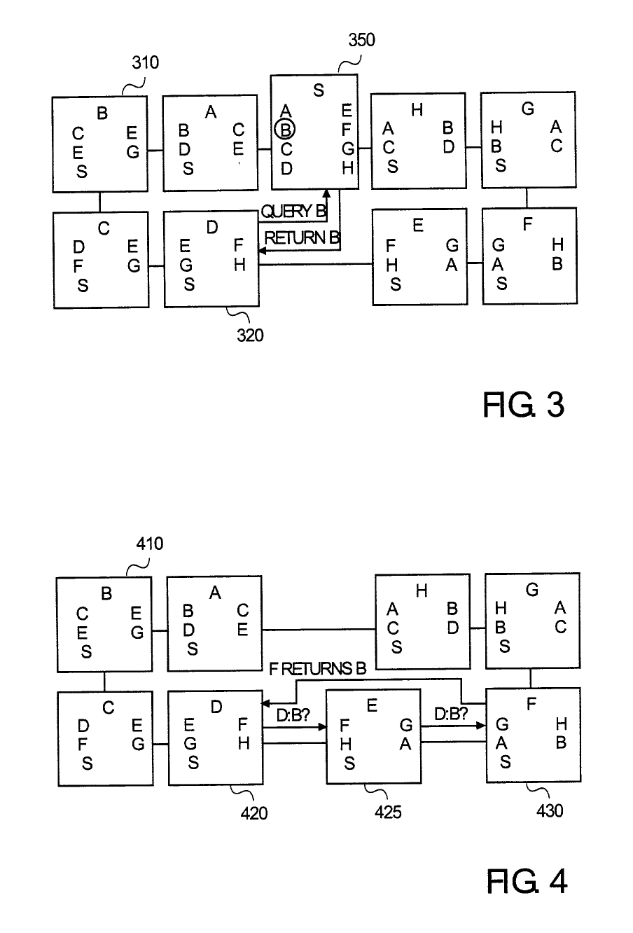

FIG. 2 illustrates a peer-to-peer network with the normal peers having information about other normal peers. The peer-to-peer network 200 includes the normal peers 205-240 and a super-peer 250. The normal peer 220 includes information about the four other normal peers 225, 230, 240, and 245. Similarly, the normal peer 240 includes information about four other normal peers 205, 210, 215, and 220. The number of normal peers to include the information may be static for each normal peer. The number of times information about a normal peer is distributed in the network is referred to as a redundancy factor. That is, the more times the information is distributed, the more redundant the information is in the network, and thus the faster the discovery lookup for the corresponding normal peer. The redundancy factor ensures that all information of network is present even if some of the normal peers go down. Note that the desire to distribute the information is dependent on the capability of the normal peers to accept the information. For example, a handheld normal peer cannot be forced to include information about another normal peer when its capability rating does not permit having such information.

FIG. 3 illustrates a discovery lookup process using the super-peer. When the normal peer 320 wants to find the normal peer 310, the normal peer 320 first checks to see if it already has information about the normal peer 310. If this information is not found, the normal peer 320 queries the super-peer 350 to get the information about the normal peer 310. As part of the namespace directory, the super-peer 150 is expected to have information about all of the normal peers in the network, including that of the normal peer 310. However, there may be times when the super-peer is unable to locate a requested or desired normal peer. When this occurs, the super-peer 350 may return an error message. For example, when the requested normal peer is a new normal peer and the super-peer 350 may not have been updated with information about the new normal peer.

Every normal peer in the network has the responsibility of updating changes in its directory to the super-peer. This ensures that the other normal peers can reach the normal peer experiencing the changes. In some situations, even with the information from the super-peer, the requested normal peer cannot be contacted because it may have been removed from the network and the super-peer may not have been updated. When this occurs, a notice may be sent by the requesting peer to the super-peer to update its directory. The super-peer may then send notice to all of the other normal peers to update their directories. For example, because each normal peer knows its own IP address, when there is a change to a new IP, the normal peer informs the super-peer of the new IP. The super-peer in turn informs this change to the other normal peers that know about the normal peer having the new IP. Note that a normal peer may have a new IP address even though its PUID remains the same.

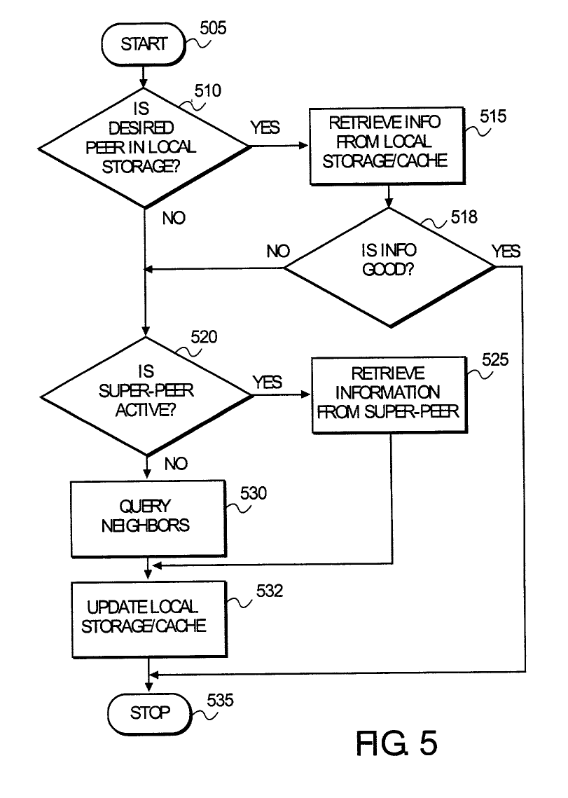

FIG. 4 illustrates a discovery lookup process without using the super-peer. When a super-peer fails, notice is sent to all the normal peers in the network to enable the normal peers to update their individual directories. Without the super-peer, the network according to the present invention is still operable by using the information about the neighbors. The network in FIG. 4 does not include a super-peer. When the normal peer 420 wants to find the normal peer 410, recognizing that there is no super-peer, the normal peer 420 queries its known neighbor normal peer 425 to check if the normal peer 425 includes information about the normal peer 410. If the normal peer 425 has the information, that information is sent back to the normal peer 420. However, in this example, because the normal peer 425 does not include the desired information, the normal peer 425 propagates the query to its neighbor normal peer 430. When the information about the normal peer 410 is located, that information is sent to the requesting normal peer 420. Thus, the network is still operational without a centralized server like a super-peer.

In one embodiment, a query to locate the information about the desired normal peer is sent to all of the known neighbor normal peers at the same time. In another embodiment, the propagation of the query is limited so as to prevent unlimited propagation of the query. Any method may be used to limit the propagation. For example, a hop count limit may be set to control how far the query is propagated. A hop count corresponds to each time the query is propagated from one normal peer to its neighbor normal peers. As another example, a time limit may be used to prevent a time stamped query to propagate after a predetermined length of time. As described above, a normal peer may include information about other normal peers that it frequently communicates with in its dynamic cache.

Because the information about a normal peer may be distributed to multiple other normal peers (described above as the redundancy factor), in some situations, the requesting normal peer may be flooded with duplicate information. To prevent this from happening, a filtration mechanism may be used. For example, after the requesting normal peer receives the requested information a first time, subsequent duplicate information is ignored. In another example, filtration may be done by figuring out a timestamp associated with each information and rejecting the information received after a certain length of time. Each normal peer provides the timestamp when it sends out the information to the requesting normal peer.

A request for information about a normal peer may arrive at another peer directly from the requesting normal peer or indirectly through another normal peer. As such, a normal peer may receive duplicate requests. In this situation, a filtration to discard or ignore the duplicate requests may be done by keeping track of the identity of the requesting normal peer and examining the timestamp associated with the query.

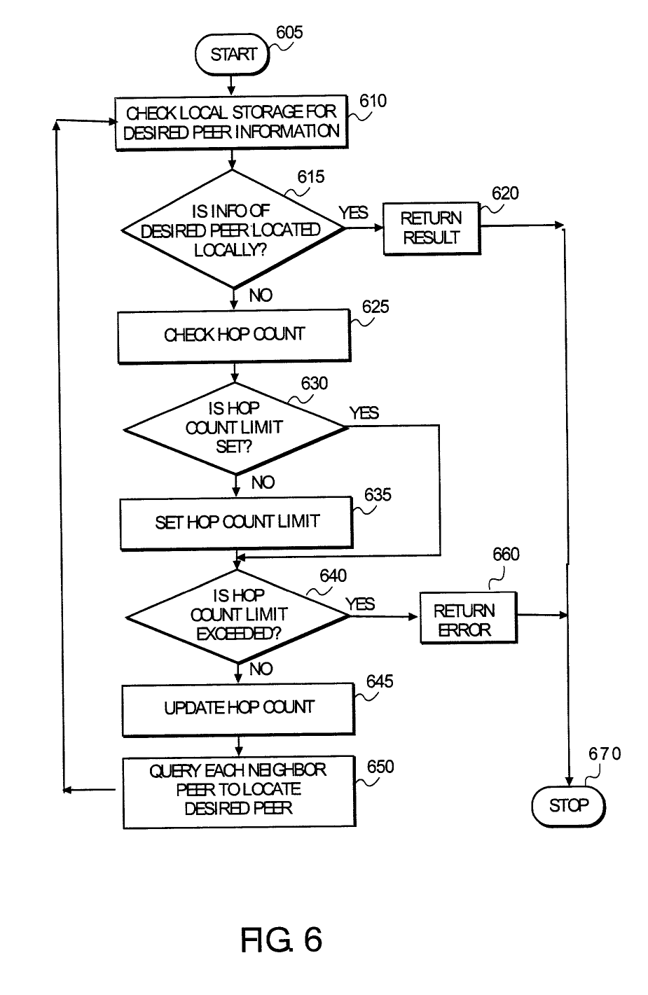

FIG. 5 is a flow diagram illustrating a process of locating information about a desired normal peer. The process starts at block 505. At block 510, a determination is made to see if the information about the desired normal peer is already included in the directory of the requesting normal peer. When the information is already there, the process flows to block 515 where the information is retrieved from the storage of the requesting normal peer. Note that this may be from the static storage or from the dynamic cache. At block 518, a test is made to determine if the retrieved information is still good (e.g., the information may be stale). When the retrieved information is still good, the process moves to block 535. From block 518, when the retrieved information is not good, the process flows to block 520 to see if the requested information can be retrieved from a super-peer.

From block 510, if the requested information is not in the local storage, the process flows to block 520 to see if the requested information can be retrieved from a super-peer. First, a determination is made to see if there is even a super-peer in the network, as shown in block 520. When there is a super-peer, the process flows to block 525 where the information about the desired normal peer is retrieved from the super-peer. The retrieved information is then stored in the local storage of the requesting normal peer, as shown in block 532.

From block 520, when there is no super-peer in the network, the process flows to block 530 where the requesting normal peer begins querying its neighbor normal peers for the information about the desired normal peer. One or more of the neighbor peers will then send information about the desired normal peer to the requesting normal peer. This information is then stored in the local storage of the requesting normal peer, as shown in block 532. The process stops at block 535.

FIG. 6 is a flow diagram illustrating a lookup process of querying the neighbor normal peers. This process provides further details about the operation performed in block 530 of FIG. 5. The process starts at block 605. Note that a query or request for information about a desired peer may include hop count information. The hop count information may be previously set as the request is propagated to neighboring peers.

At block 610, the local storage of a peer is checked to see if the requested information is already there. At block 615, the result of the check in block 610 is verified to determine if the requested information is located in the local storage. When the requested information is located in the local storage, the process flows to block 620 where the information is retrieved and sent back to the requesting peer. The process then stops at block 670.

From block 615, when the requested information is not located in the local storage, the process flows to block 625 where the hop count is checked. Note that a hop count limit is set one time as the request begins to be propagated to the neighbor peers. As the request continues to be propagated, the hop count does not need to be set but only need to be updated. At block 630, a test is made to determine if the hop count limit has already been set. When the hop count limit is set, the process flows to block 640. When the hop count limit is not already set, the hop count limit is set in block 635 and the process flows to block 640.

As described earlier, the hop count limit helps preventing the request to be propagated indefinitely. At block 640, a test is made to determine if the hop count limit is exceeded. When the hop count is not exceeded, the process flows from block 640 to block 645 where the hop count is updated. At block 650, the request or query is sent to each neighbor peer to locate the desired peer. The process then flows to block 610 to check the local storage of the neighbor peer for the requested information. From block 640, when the hop count is exceeded, the process flows to block 660, and an error is sent to the requesting peer. The process then stops at block 670.

There may be a limit to the amount of information about the normal peers that a super-peer may be able to handle. As described earlier, this limit may be due to the capability rating of the super-peer. As new normal peers join the network, the super-peer may need help offloading the additional information. In one embodiment, the super-peer may delegate one or more normal peers to become additional super-peers. A normal peer may include a willingness rating to indicate if the normal peer is willing to be a super-peer. This willingness rating may be independent from the capability rating of the normal peer. For example, a high capability rating normal peer may have a low willingness rating and thus would be less likely to be selected as a super-peer. A normal peer that goes offline often may have a low willingness rating. When there are multiple super-peers in the network, each super-peer has an exclusive set of information about the normal peers in the network. In one embodiment, when there are multiple super-peers, a query for information about a normal peer is sent to one super-peer. When that super-peer cannot resolve the query, the query is propagated to another super-peer. This provides a multi-level super-peer hierarchy. The normal peers and the super-peers also form a two level hierarchy.

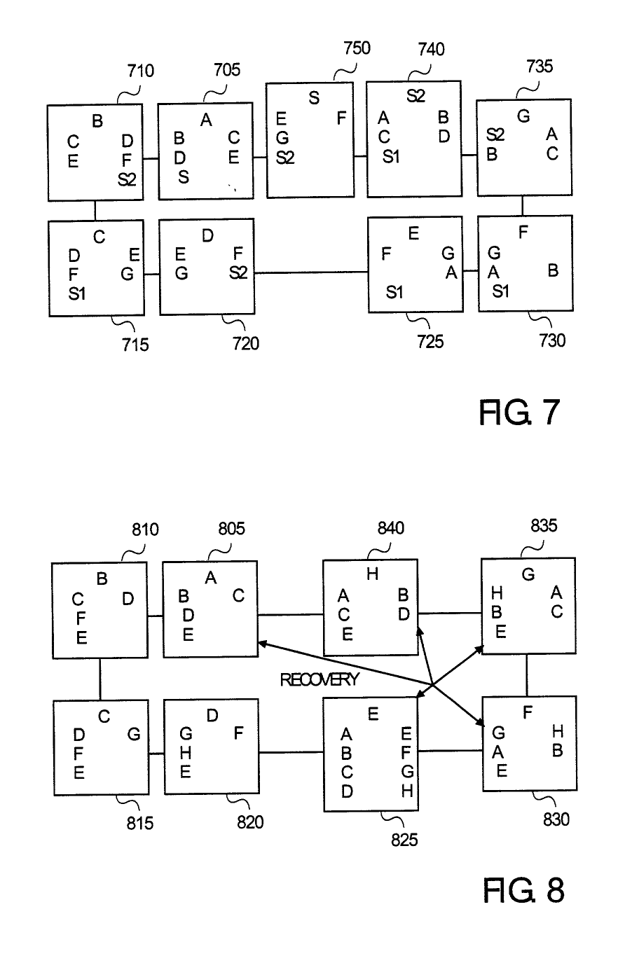

A super-peer is a normal peer with more responsibilities and may not need to have specialized software/mechanisms more than what a normal peer may have. Specialized mechanisms (like database, etc.) may be used to enhance operation of the super-peer. FIG. 7 illustrates an example of a network with more than one super-peer. The network includes two super-peers 750 (S1) and 740 (S2). The information about the normal peers included in the super-peer 750 and the information about the normal peers included in the super-peer 740 together constitute the information about all of the normal peers 705-735 in the network including the super-peers 740 and 750. In one embodiment, each of the normal peers 705-735 includes information about one of the super-peers in the network. A super-peer also includes information about the other super-peers. Thus, the network may have a single super-peer (or server) or multiple super-peers. In one embodiment, the directories of two or more super-peers may be combined together and stored in one super-peer, turning the network from having multiple super-peers to a network having one super-peer.

FIG. 8 illustrates one example of recovery of a super-peer. Recognizing that there is no super-peer in the network, one or more of the normal peers may declare to be a super-peer. For example, the normal peer 825 (E) may try to take over the responsibilities of a super-peer if its willingness rating and capability rating allow it to do so. Other methods for selecting a super-peer from the normal peers may also be performed. In this example, the normal peer 825 sends a message indicating its intention to all of its neighbor normal peers. From these neighbor normal peers, the message is then propagated to their neighbor normal peers. The propagation may be limited using, for example, hop counts.

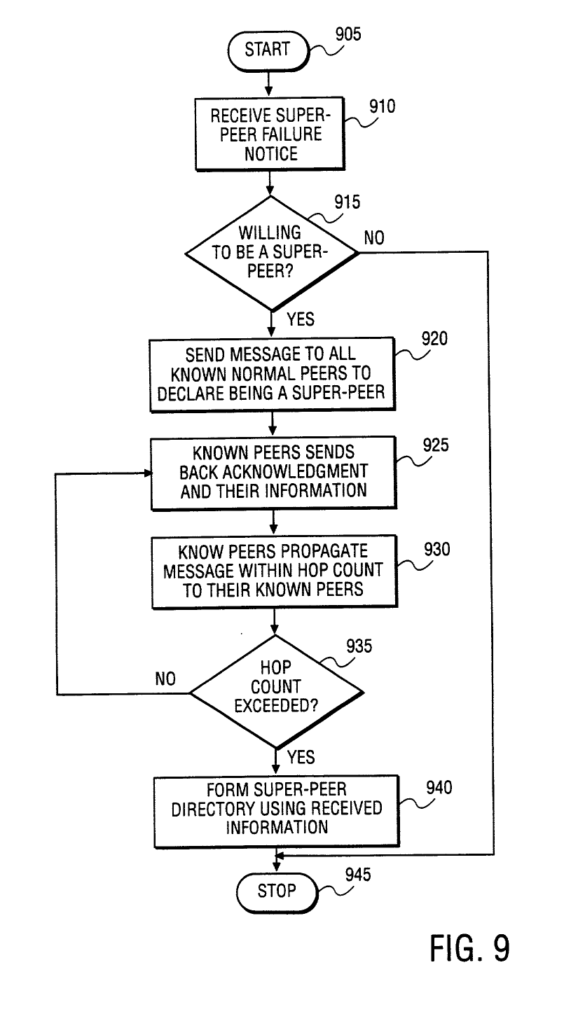

FIG. 9 is a flow diagram illustrating a process of recovery of a super-peer. The process starts at block 905. When a super-peer fails, any other peers having sufficient capability rating and willingness rating may become a replacement super-peer. At block 910, a notice is received to indicate that there is not super-peer in the network. At block 915, a determination is made to see if the current normal peer is willing to be a super-peer based on its willingness rating. If there is no sufficient willingness rating, the process flows from block 915 to block 945. However, if there is sufficient willingness rating, the process flows from block 915 to block 920 where a declaration message is sent by the current normal peer to all of its neighbor normal peers to indicate that the current normal peer wants to become a super-peer.

At block 925, the neighbor normal peers send an acknowledgement to the current normal peer together with their information. At block 930, the declaration message is propagated from these neighbor normal peers to their neighbor normal peers. At block 935, a hop count limit is determined to control the propagation of the declaration message. If the hop count is still within a predetermined limit, the process flows from block 935 block 925. From block 935, if the hop count is exceeded, the process flows to block 940 where the current normal peer updates its directory using the information received from all of the normal peers in the network. The process stops at block 945.

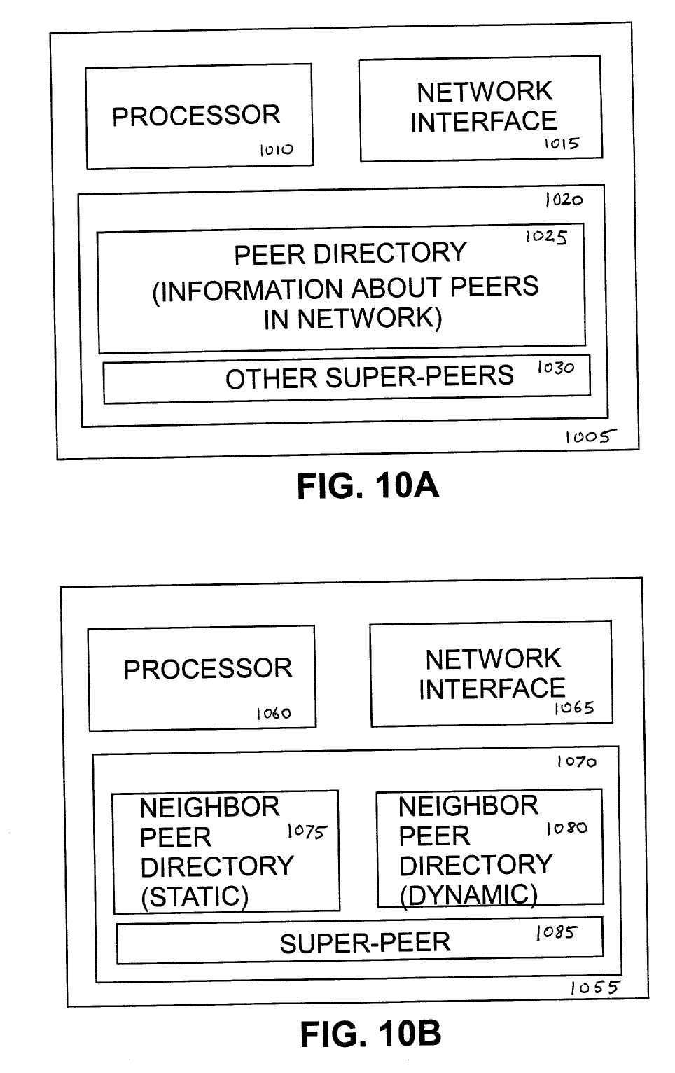

FIGS. 10A and 10B are block diagrams illustrating examples of a super-peer and a normal peer, respectively. The super-peer 1005 includes a processor 1010 and a network interface 1015. The super-peer 1005 also includes a memory 1020. The memory 1020 includes a peer directory 1025 which contains information about all of the normal peers in the network. The memory 1020 may also include information about other super-peers in the network when there is more than one super-peer in the network.

The normal peer 1055 includes a processor 1060 and a network interface 1065. The network interface 1065 may be used for wired or wireless connection to a network. The normal peer 1055 also includes a memory 1070. The memory 1070 includes static neighbor peer directory containing information about neighbor peers. The memory 1070 also includes dynamic neighbor peer directory containing information about neighbor peers that the normal peer 1055 recently communicates with. In addition, the memory 1070 also includes information about the super-peer in the network.

The operations of the various methods of the present invention may be implemented by a processing unit in a digital processing system, which executes sequences of computer program instructions which are stored in a memory which may be considered to be a machine readable storage media. The memory may be random access memory, read only memory, a persistent storage memory, such as mass storage device or any combination of these devices. Execution of the sequences of instruction causes the processing unit to perform operations according to the present invention. The instructions may be loaded into memory of the computer from a storage device or from one or more other digital processing systems (e.g. a server computer system) over a network connection. The instructions may be stored concurrently in several storage devices (e.g. DRAM and a hard disk, such as virtual memory). Consequently, the execution of these instructions may be performed directly by the processing unit.

In other cases, the instructions may not be performed directly or they may not be directly executable by the processing unit. Under these circumstances, the executions may be executed by causing the processor to execute an interpreter that interprets the instructions, or by causing the processor to execute instructions which convert the received instructions to instructions which can be directly executed by the processor. In other embodiments, hard-wired circuitry may be used in place of or in combination with software instructions to implement the present invention. Thus, the present invention is not limited to any specific combination of hardware circuitry and software, nor to any particular source for the instructions executed by the computer or digital processing system

Thus, methods and systems for peer-to-peer communication in a network have been described. The network may be server-centric or non-server centric. When operating in a server-centric fashion, there may be one or more servers (or super-peers) working together to provide information to the clients (or normal peers). When operating in a non-server centric fashion, the peers work with each other to provide the requested information.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method, comprising:
when a server is active in a network, querying the server for information about a desired peer in the network; and
when the server is not active in the network, querying neighbor peers for information about the desired peer.

2. The method of claim 1, wherein the server includes a server peer directory containing information about peers in the network.

3. The method of claim 1, wherein the each of the peers in the network includes a neighbor peer directory containing information about the neighbor peers.

4. The method of claim 3, further comprising:
determining if the desired peer is located in the neighbor peer directory prior to querying the server; and
retrieving the information about the desired peer from a local storage when the desired peer is located in the neighbor peer directory.

5. The method of claim 4, wherein querying the neighbor peers comprises:
querying each of the neighbor peers included in the neighbor peer directory to locate the desired peer; and
when the desired peer is located in the neighbor peer, retrieving the information about the desired peer from the neighbor peer.

6. The method of claim 1, wherein when the server is not active in the network, at least one of the peers in the network becomes a replacement server.

7. The method of claim 6, wherein the at least one of the peers in the network becomes a replacement server by broadcasting a message to the peers in the network.

8. The method of claim 7, wherein the at least one of the peers in the network becomes a replacement server by receiving positive acknowledgement to the broadcasted message from the peers in the network.

9. The method of claim 6, wherein the at least one of the peers in the network becomes a replacement server if the peer has sufficient capability rating.

10. The method of claim 9, wherein the capability rating includes previously set indication that the peer is capable of performing as the replacement server.

11. A peer system, comprising:
a network interface to connect to a network;
a processor coupled with the network interface;
a memory coupled with the processor and the network interface, the memory including a neighbor peer directory having information about zero or more neighbor peers in the network, wherein when searching for a desired peer, the neighbor peer directory is first searched to locate the desired peer, and when the desired peer is not located in the neighbor peer directory, a query is sent to a server connected to the network to search for the desired peer.

12. The system of claim 11, wherein the query is sent to the server when the server is active.

13. The system of claim 12, wherein the server includes a server-peer directory having information about all peers in the network.

14. The system of claim 12, wherein when the server is not active, the query is sent to each of the neighbor peers included in the neighbor peer directory.

15. The system of claim 12, wherein when the server is not active, one or more peers in the network becomes a replacement server.

16. A computer readable medium containing executable instructions which, when executed in a processing system, causes the processing system to perform a method comprising:
when a server is active in a network, querying the server for information about a desired peer in the network; and
when the server is not active in the network, querying neighbor peers for information about the desired peer.

17. The computer readable medium of claim 16, wherein the server includes a server peer directory containing information about peers in the network.

18. The computer readable medium of claim 16, wherein the each of the peers in the network includes a neighbor peer directory containing information about the neighbor peers.

19. The computer readable medium of claim 18, further comprising:
determining if the desired peer is located in the neighbor peer directory prior to querying the server; and
retrieving the information about the desired peer from a local storage when the desired peer is located in the neighbor peer directory.

20. The computer readable medium of claim 19, wherein querying the neighbor peers comprises:
querying each of the neighbor peers included in the neighbor peer directory to locate the desired peer; and
when the desired peer is located in the neighbor peer, retrieving the information about the desired peer from the neighbor peer.

21. The computer readable medium of claim 16, wherein when the server is not active in the network, at least one of the peers in the network becomes a replacement server.

22. The computer readable medium of claim 21, wherein the at least one of the peers in the network becomes a replacement server by broadcasting a message to the peers in the network.

23. The computer readable medium of claim 22, wherein the at least one of the peers in the network becomes a replacement server by receiving positive acknowledgement to the broadcasted message from the peers in the network.

24. The computer readable medium of claim 21, wherein the at least one of the peers in the network becomes a replacement server if the peer has sufficient capability rating.

25. The computer readable medium of claim 24, wherein the capability rating includes previously set indication that the peer is capable of performing as the replacement server.

26. A peer system, comprising:
means for locating a desired peer by querying a neighbor peer directory, the neighbor peer directory including information about neighbor peers, the neighbor peers connected to a network;
means for locating the desired peer by querying a server connected to the network; and
means for locating the desired peer by querying the neighbor peers.

27. The system of claim 26, wherein the server includes information about all peers connected to the network.

28. The system of claim 26, wherein the neighbor peers are queried when the server is not active.
